(19) United States
(12) Patent Application Publication
(10) Pub. No.: US 2003/0221098 A1
(43) Pub. Date: Nov. 27, 2003

(54) Method for automatically updating a network ciphering key

(76) Inventors: Kun-Huei Chen, Taipei Hsien (TW); Ju-Nan Chang, Taipei Hsien (TW); Wen-Biao Lee, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,891

(22) Filed: May 22, 2002

(51) Int. Cl. H04L 9/00

(52) U.S. Cl. 713/153; 380/273

(57) ABSTRACT

A method for automatically updating a ciphering key used in a network system. The network system has a server, an access point connected to the server, a station, and a counting module. The access point is used to transmit data received from the server via wireless transmission, and receive data transmitted via wireless transmission. The access point uses a first ciphering key to encrypt transmission data. The method includes: detonating the counting module to start counting the time; randomly generating a second ciphering key if the time counted by the counting module conforms to a predetermined time; the access point transmitting the second ciphering key to the station so as to update the first ciphering key stored in the station with the second ciphering key; and using the second ciphering key to encrypt data transmitted between the access point and the station.

### BACKGROUND OF INVENTION

1. Field of the Invention

The present invention is related to a method for updating a ciphering key used in a wireless network, and more particularly, to a method for automatically updating a ciphering key used in a wireless network.

2. Description of the Prior Art

As network technology develops day-by-day, users can conveniently and easily transmit data through network systems. Users no longer need to carry hard-discs or floppy-discs to store data for further saving data in another device. In addition, the data stored in the hard-discs or floppy-discs is easily lost due to damage of the hard-discs or soft-discs. However, digital data transmitted through networks is not easily damaged. Users can use network systems to transmit digital data quickly and safely. With special regard to the development of wireless networks over the recent years, because a physical network transmission line is not required, the ability to connect a station to a wireless network has brought the characteristics of portability and mobility to a user so that the user may access network resources at any place and at any time.

Although users can transmit data conveniently and quickly through wireless networks, the data is not secure. Since data is transmitted through radio waves in wireless network systems, a third party can easily steal data during transmission. In order to prevent someone from stealing data while transmitting, data is encrypted before transmitting through a wireless network.

Please refer to FIG. 1. FIG. 1 is a block diagram of a prior art wireless network system 10. The wireless network system 10 comprises a server 12, at least an access point 14, and a plurality of stations T1, T2 and T3. Each station T1, T2 and T3 can transmit data to the access point 14 via wireless transmission and receive data transmitted from the access point 14 via wireless transmission. Similarly, the access point 14 can also transmit data to each station T1, T2 and T3 via wireless transmission and receive data transmitted from the station T1, T2 and T3 via wireless transmission. All data transmission inside the wireless network system complies with a wireless network protocol (such as the IEEE 802.11 specification). The access point 14 and the server 12 are connected to each other in wired or wireless manner. Therefore, data transmitted between the access point 14 and the server 12 can be transmitted via wireless transmission or wired transmission. In the present embodiment, data transmitted between the access point 14 and the server 12 is transmitted via wired transmission. Data also can be transmitted or exchanged between stations T1, T2 and T3 through the service provided by the access point 14 and the server 12. For example, if station T1 wants to transmit data to the station T2, station T1 can first transmit the data to the access point 14 via wireless transmission, and then the access point 14 transmits the data to the station T2. Therefore, data can be successfully transmitted from the station T1 to the station T2 through the access point 14. Similarly, data also can be transmitted between the station T1 and station T3 through the access point 14.

The server, access point 14, and stations T1, T2, T3 inside the wireless network system 10 can exchange data with each other quickly and conveniently, but the data transmitted via wireless transmission can easily be eavesdropped and stolen by a third party. Therefore, data must be encrypted before transmitting so as to prevent eavesdropping by the third party. In order to encrypt data, each station T1, T2, T3 and access point 14 inside the wireless network system 10 must store an identical ciphering key K for encrypting and decrypting the transmitting data. The devices inside the same wireless network system store the same ciphering key. With regards to FIG. 1, the access point 14 and each station T1, T2, T3 all store a same ciphering key K for encrypting and decrypting data. Therefore, data can be transmitted safely inside the wireless network system 10. The data transmission process can be illustrated as follows. When the station T1 wants to transmit data to the access point 14, the station T1 first uses the ciphering key K to encrypt the data. Then the station T1 transmits the encrypted data to the access point 14 via wireless transmission. After the access point 14 receives the encrypted data transmitted from the station T1, the access point uses the same ciphering key K to decrypt the data so as to get the real data transmitted from the station T1. Similarly, when the access point 14 wants to transmit data to the station T1, the access point 14 also uses the ciphering key K to encrypt the data. Then the access point 14 transmits the data to the station T1 so as to let the station T1 can further decrypt and get the data. Therefore, data can be transmitted inside the wireless network system 10 confidentially and without being eavesdropped by the third party.

In addition, each station T1, T2, T3 inside the wireless network system 10 stores an individual identification data D1, D2, D3. For example, the station T1 stores the identification data DI. The stations T2 and T3 respectively store the identification data D2 and D3. The identification data D1 contains a user identification code ID1, a login password PW1, and a station address Add1, and so on. The same is true for the identification data D2 and D3. In addition, the server 12 stores a registration data D corresponding to the identification data D1, D2, D3. The registration data D contains information about each station T1, T2, T3. The stations T1, T2, T3 use the identification data D1, D2, D3 to enter the wireless network system 10. The server 14 confirms the identity of the stations T1, T2, T3 according to the registration data D so as to control data access of each station T1, T2, T3, such as limit of access authority control, access address control, and so on.

As mentioned above, the stations and access point inside the same wireless network system use the same ciphering key. In prior art network management practice, the ciphering key K is manually inputted (such as through use of the keyboard) into each station T1, T2, T3 and access point 14 one by one by network operators. Therefore, except for the network operators, users of each station T1, T2, T3 do not know the content of the ciphering key K. The ciphering key K is kept secret so as to protect the data. However, if one of the stations T1, T2, T3 withdraws from the wireless network system 10 (for example, the wireless network system 10 is a payment network system, a user of a station does not pay any more money and withdraws from the services provided by the payment network system), the stations T1, T2, T3 can also use the ciphering key K to access data inside the wireless network system 10 since the ciphering key K is still stored in the stations T1, T2, T3. In order to prevent the data inside the wireless network system 10 from being eavesdropped by someone, the network operators must manually change to a new ciphering key for the stations T1, T2, T3 and the access point 14 one by one, after one of the stations T1, T2, T3 withdraws the wireless network system 10. Thus, every time one of the stations T1, T2, T3 withdraws the wireless network system 10, the network operators must change a new ciphering key for the devices one by one. This is inconvenient and also consumes great time and manpower. In addition, since the network operators know the content of the ciphering key K, the ciphering key K is not truly secret. It is possible that illegal users may obtain knowledge of the ciphering key K.

### SUMMARY OF INVENTION

It is therefore a primary objective of the claimed invention to provide a method for automatically updating a ciphering key used in a wireless network system, so as to truly keep the ciphering key and data secret.

In a preferred embodiment, the claimed invention provides a method for automatically updating a ciphering key used in a network system. The network system comprises a server, an access point connected to the server, a station, and a counting module. The access point is used to transmit data received from the server via wireless transmission, and receive data transmitted via wireless transmission. The access point uses a first ciphering key to encrypt transmission data. The station is used to receive data transmitted from the access point via wireless transmission, and transmit data to the access point via wireless transmission. The station stores the first ciphering key for encrypting data transmitted to the access point. The counting module is installed in the server, the access point, or the station, for counting a time. The method comprises: detonating the counting module to start counting the time; randomly generating a second ciphering key if the time counted by the counting module conforms to a predetermined time; the access point transmitting the second ciphering key to the station so as to update the first ciphering key stored in the station with the second ciphering key; and using the second ciphering key to encrypt data transmitted between the access point and the station.

It is an advantage of the claimed invention that the network operators do not need to spend time and manpower to manually change the old ciphering key to the new ciphering key one by one. Moreover, since the ciphering key is generated by the random-code generation program, none of the network operators and users of the stations know the content of the new ciphering key. Thus, the ciphering key can truly be kept secret. In addition, the ciphering key is updated randomly and frequently, thereby preventing network hackers from invading into the wireless network system.

These and other objectives of the present invention will no doubt become obvious to those of ordinary skill in the art after having read the following detailed description of the preferred embodiment, which is illustrated in the various figures and drawings.

### BRIEF DESCRIPTION OF DRAWINGS

FIG. 1 is a block diagram of a prior art wireless network system.

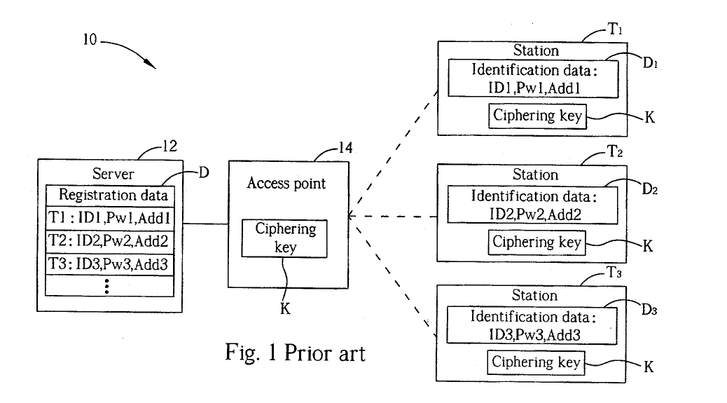

FIG. 2 is a structural diagram of a present invention wireless network system.

FIG. 3 is a flow chart of a present invention method for automatically updating a ciphering key of the wireless network system.

### DETAILED DESCRIPTION

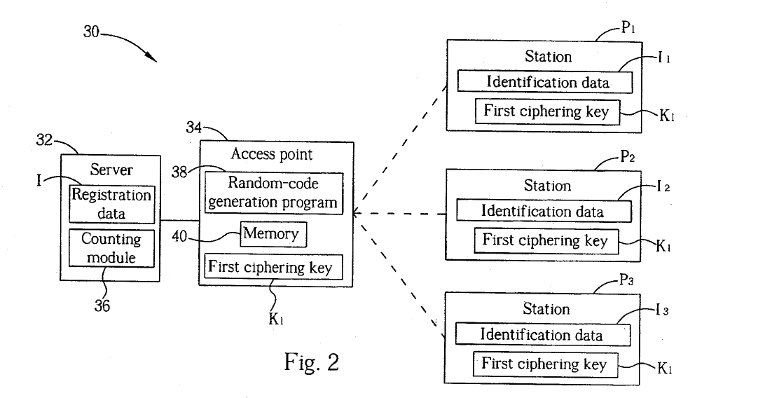

Please refer to FIG. 2. FIG. 2 is a structural diagram of a present invention wireless network system 30. The wireless network system 30 comprises a server 32, at least an access point 34, and a plurality of stations P1, P2, P3. The access point 34 and the stations P1, P2, P3 all store an identical first ciphering key K1. Each station P1, P2, P3 stores an individual identification data I1, I2, I3. The server 32 stores a registration data I corresponding to the identification data I1, I2, I3 so as to control data access of the stations P1, P2, P3. The difference between the present invention wireless network system 30 and the prior art wireless network system 10 is that the server 32 of the present invention wireless network system 30 further comprises a counting module 36, and the access point 34 further comprises a random-code generation program 38. The counting module 36 is used to count a real time. When the time counted by the counting module 36 conforms a predetermined time, the counting module 36 sends a signal to the access point 34 to detonate the random-code generation program 38 to generate a new second ciphering key K2. Then, the server 32 controls the stations P1, P2, P3 and the access point 34 to update the first ciphering key K1 into the second ciphering key K2. The update method is illustrated as follows.

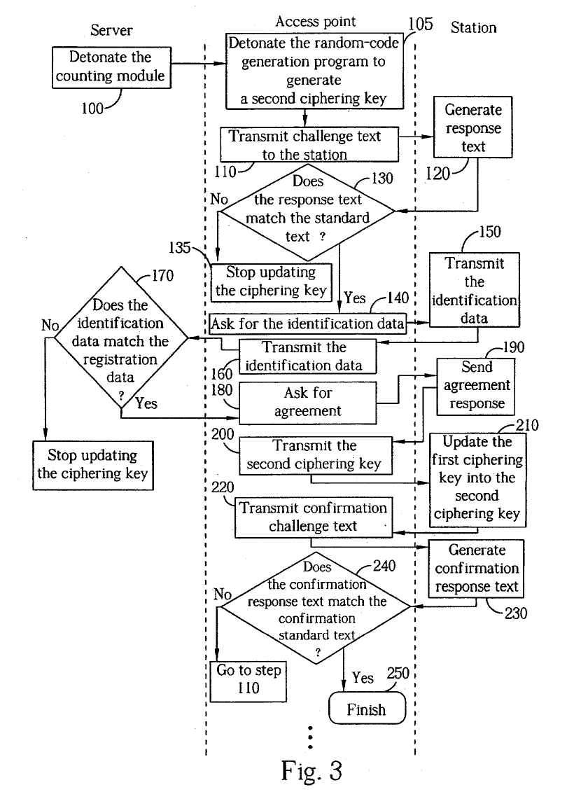

Please refer to FIG. 3. FIG. 3 is a flow chart of the present invention method for automatically updating the ciphering key of the wireless network system 30. The procedures of the present invention method are illustrated as follows (use station P1 as an example):

Step 100:

Detonate the counting module 36 inside the server 32 to start counting the time;

Step 105:

If the time counting by the counting module 36 conforms the predetermined time, the counting module 36 sends a signal to the access point 34 to detonate the random-code generation program 38 inside the access point 34 to randomly generate a second ciphering key K2;

Step 110:

After the random-code generation program 38 generates the second ciphering key K2, the access point 34 transmits a challenge text to the station P1 via wireless transmission to confirm whether the station P1 has the first ciphering key K1; since it is not yet determined whether the station P1 has a first ciphering key, the challenge text transmitted from the access point 34 to the station P1 is not encrypted by the first ciphering key K1;

Step 120:

After receiving the challenge text, the station P1 uses the first ciphering key K1 to encrypt the challenge text into a response text and then transmits the response text to the access point 34;

Step 130:

The access point 34 also uses the first ciphering key K1 to encrypt the challenge text into a standard text; after the access point 34 receives the response text transmitted from the station P1, the access point 34 compares the response text with the standard text, if the response text matches the standard text, that means the station P1 has the first ciphering key K1, execute step 140; but, if the response text does not match the standard text, that means the station P1 does not have the first ciphering key K1 and does not belong to the wireless network system 30, therefore, execute step 135;

Step 135:Stop updating the ciphering key for the station P1;

Step 140:

The access point 34 asks the station P1 to transmit the identification data I1 so as to confirm whether the station P1 belongs to the wireless network system 30; since the station P1 has confirmed having the first ciphering key K1 at that time, from this step, the data transmitted between the station P1 and the access point 34 can be encrypted by the first ciphering key K1 so as to keep the transmitted data secret;

Step 150:

After receiving the signal transmitted from the access point 34, the station P1 uses the first ciphering key K1 to encrypt the identification data I1 and then transmits the encrypted identification data I1 to the access point 34;

Step 160:

After receiving the identification data I1 transmitted from the station P1, the access point 34 uses the first ciphering key K1 to decrypt the identification data I1 and then transmits the decrypted identification data I1 to the server 32;

Step 170:

After receiving the identification data transmitted from the access point 34, the server 32 compares the identification data I1 with the registration data I, if the identification data I1 matches the registration data I, the station P1 is further confirmed as belonging to the wireless network system 30, execute step 180; otherwise, the station P1 does not belong to the wireless network system 30, therefore, stop updating the ciphering key for the station P1;

Step 180:

After the station P1 is confirmed as belonging to the wireless network system 30 by the server 32, the access point 34 sends out a request to the station P1 to ask whether the user of the station P1 wants to update the ciphering key;

Step 190:

After the user of the station P1 receives the request transmitted from the access point 34, the station P1 can send out an agreement response to the access point 34;

Step 200:

After receiving the agreement response transmitted from the station P1, the access point 34 uses the first ciphering key K1 to encrypt the second ciphering key K2 and then transmits the encrypted second ciphering key K2 to the station P1;

Step 210:

After receiving the encrypted second ciphering key K2 transmitted from the access point 34, the station P1 uses the first ciphering key K1 to decrypt the encrypted second ciphering key K2 so as to get the real second ciphering key K2, then the station P1 updates the first ciphering key K1 into the second ciphering key K2;

Step 220:

In order to confirm whether the station P1 has successfully updated the first ciphering key K1 into the second ciphering key K2, the access point 34 transmits a confirmation challenge text to the station P1, this confirmation challenge text is not encrypted by the first ciphering key K1 or the second ciphering key K2;

Step 230:

After receiving the confirmation challenge text transmitted from the access point 34, the station P1 uses the second ciphering key K2 to encrypt the confirmation challenge text into a confirmation response text, and then transmits the confirmation response text to the access point 34;

Step 240:

The access point 34 also uses the second ciphering key K2 to encrypt the confirmation challenge text into a confirmation standard text; after receiving the confirmation response text transmitted from the station P1, the access point 34 compares the confirmation response text to the confirmation standard text, if the confirmation response text matches the confirmation standard text, that means the station P1 has successfully updated the first ciphering key K1 into the second ciphering key K2, therefore, the follow up transmission data between the access point 34 and the station P1 is encrypted and decrypted by the second ciphering key K2, therefore, continuously execute step 250; but, if the confirmation response text does not match the confirmation standard text, that means the station P1 has not updated the first ciphering key K1 into the second ciphering key K2 yet, therefore, go back to step 110; and

Step 250:

The first ciphering key K1 is successfully updated into the second ciphering key K2, the access point 34 and the station P1 use the second ciphering key K2 to encrypt or decrypt the transmission data until the next time that the counting module 36 detonates the random-code generation program 38 to generate a third ciphering key K3, then repeat the above steps to update the second ciphering key K2 into the third ciphering key K3, therefore, the common ciphering key inside the wireless network system 30 is changed unceasingly, the common ciphering key and the transmission data inside the wireless network system 30 can be kept secret.

The counting module 36 of the embodiment mentioned above is installed inside the server 32, and the random-code generation program 38 is stored inside the access point 34. However, the present invention is not limited in that. The present invention counting module 36 can also be installed inside the access point 34. The random-code generation program 38 also can be stored inside the server 32. As long as the random-code generation program 38 is detonated to generate a new ciphering key each time the counting module 36 conforms to a predetermined time, it is covered by the disclosure of the present invention. In addition, the predetermined time can be a fixed time or a non-fixed time. That means the wireless network system 30 can update the common ciphering key according to a fixed time or a random time. No matter if the common ciphering key is updated according to a fixed time or a random time, the ciphering key also can be automatically updated.

The access point 34 further comprises a memory 40 for recording the new ciphering key and all old ciphering keys. Assume that the new ciphering key of the wireless network system 30 is the third ciphering key K3. The memory 40 records the third ciphering key K3, the second ciphering key K2, and the first ciphering key K1. Therefore, even if the station P1 cannot synchronously update the ciphering key with the access point 34 for some reason (such as the station P1 is turned off), the station P1 will not be withdrawn out of the wireless network system 30. For example, the random-code generation program 38 generates the third ciphering code K3. However, the station P1 has not updated the first ciphering key K1 into the second ciphering key K2 yet for some reason (such as the station P1 is turned off or other reasons). Since the access point 34 still stores the second ciphering key K2, the station P1 still can update the first ciphering key K1 into the second ciphering key K2, and then updates the second ciphering key K2 into the third ciphering key K3, or directly updates the first ciphering key K1 into the third ciphering key K3. Therefore, the station P1 will not be withdrawn out of the wireless network system 30 for not synchronously updating the ciphering key with the access point 34.

In contrast to the prior art method, the present invention method detonates the random-code generation program 38 to generate a new ciphering key each time the time counted by the counting module 36 conforms to a predetermined time. Then the old ciphering key stored inside the access point 34 and each station P1, P2, P3 is updated into the new ciphering key. Therefore, the network operators do not need to spend time and manpower to manually change the old ciphering key into the new ciphering key one by one. Moreover, since the ciphering key is generated by the random-code generation program, none of the network operators and the users of the stations know the content of the new ciphering key. Thus, the ciphering key can truly be kept secret. In addition, the ciphering key is updated randomly and frequently, thereby preventing network hackers from breaking into the wireless network system 30. Therefore, users that use the present invention method can not only enjoy the convenience of data transmission, but also can keep the transmitted data secret.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for automatically updating a ciphering key used in a network system, the network system comprising:
a server;
an access point connected to the server for transmitting data received from the server via wireless transmission and receiving data transmitted via wireless transmission, the access point using a first ciphering key to encrypt transmission data;
a station for receiving data transmitted from the access point via wireless transmission and transmitting data to the access point via wireless transmission and, the station storing the first ciphering key for encrypting data transmitted to the access point; and
a counting module installed in the server, the access point, or the station, for counting a time;
the method comprising:
detonating the counting module to start counting the time;
randomly generating a second ciphering key if the time counted by the counting module conforms to a predetermined time;
the access point transmitting the second ciphering key to the station so as to update the first ciphering key stored in the station with the second ciphering key; and
using the second ciphering key to encrypt data transmitted between the access point and the station.

2. The method of claim 1 wherein the station stores an identification data and the server stores a corresponding registration data, the method further comprising:
before the access point has transmitted the second ciphering key to the station, the access point transmitting a challenge text to the station via wireless transmission;
the station using the first ciphering key stored in the station to encrypt the challenge text into a response text and transmitting the response text to the access point via wireless transmission;
the access point comparing the response text with a standard text;
the station transmitting the identification data of the station to the access point via wireless transmission if the response text matches the standard text;
the access point transmitting the identification data of the station to the server; and
the access point transmitting the second ciphering key to the station if the identification data of the station matches the registration data stored in the server.

3. The method of claim 2 wherein the standard text is generated from encrypting the challenge text with the first ciphering key.

4. The method of claim 1 further comprising requesting a response from a user of the station before updating the first ciphering key of the station with the second ciphering key.

5. The method of claim 1 wherein the station uses the second ciphering key to decrypt the data received from the access point after the first ciphering key of the station is updated with the second ciphering key.

6. The method of claim 2 wherein the network system comprises a plurality of stations, and each station stores the first ciphering key and the corresponding identification data.

7. The method of claim 1 wherein the second ciphering key is randomly generated by a random-code generation program.

8. The method of claim 1 further comprising:
the access point transmitting a confirmation challenge text to the station via wireless transmission after the second ciphering key is transmitted to the station;
the station using the second ciphering key to encrypt the confirmation challenge text into a confirmation response text and transmitting the confirmation response text to the access point via wireless transmission; and
the access point comparing the confirmation response text with a confirmation standard text.

9. The method of claim 1 wherein the counting module is a real time clock (RTC) for counting a real time.
